(19) United States
(12) Patent Application Publication
(10) Pub. No.: US 2008/0129930 A1
(43) Pub. Date: Jun. 5, 2008

(54) REFLECTIVE POLARIZER CONFIGURATION FOR LIQUID CRYSTAL DISPLAYS

(75) Inventor: Michael J. Little, El Dorado Hills, CA (US)

Correspondence Address: JOSHUA D. ISENBERG;JDI PATENT, 809 CORPORATE WAY, FREMONT, CA, 94539, US

(73) Assignee: Agoura Technologies, El Dorado Hills, CA (US)

(21) Appl. No.: 11/566,103

(22) Filed: Dec. 1, 2006

(51) Int. Cl. G02F 1/1335

(52) U.S. Cl. 349/96

(57) ABSTRACT

A direct view display apparatus is disclosed. The direct view display apparatus comprises a source of backlight, a liquid crystal array; a tandem reflective polarizer having two or more reflective polarizer elements disposed in tandem between the source of backlight and the liquid crystal array; and a second polarizer. The liquid crystal array is disposed between the tandem reflective polarizers and the second polarizer. The second polarizer is an absorptive polarizer.

### FIELD OF THE INVENTION

This invention generally relates to liquid crystal displays and more particularly to liquid crystal displays that use reflective polarizers.

### BACKGROUND OF THE INVENTION

The most important attributes of a liquid crystal display (LCD), outside of cost, are contrast and brightness. Generally, higher contrast and higher brightness can only be achieved at a higher cost. Thus, as LCDs are designed/configured for each LCD application, display contrast and brightness are traded off against display cost. In nearly all instances, because the human eye is so very discerning, the display contrast needs to be at least several hundred to one or possibly as high as a few thousand to one. The perceived contrast of a LCD cannot be higher than the contrast ratio of the polarizers used. For this reason, display manufacturers can only use polarizers with a contrast ratio of at least several hundred to one. Therefore, when engineering a LCD for a particular application, since the display contrast is relatively fixed, the main variable to be traded off against display cost is brightness.

The baseline engineering approach to achieve higher brightness displays is to increase the number of lamps used in a backlight or increase their brightness. Generally, these methods adversely impact power consumption which is a severe penalty for the ever increasing number of battery operated devices with displays. Numerous innovative solutions have been developed that enable brighter displays that don't increase cost as much as the baseline engineering approach.

As shown in FIG. 1, a typical LCD is a sandwich structure consisting of several layers. The brightness efficiency of this display is very poor; typically less than 20% of the light generated by the backlight is available to the viewer. As such, innovation has been directed mainly at improvements to the brightness efficiency. //

The early brightness efficiency innovations, indicated in FIG. 2, were aimed at redirecting the oblique rays emitted by the backlight into a narrower cone of rays. The oblique rays do not contribute to the brightness perceived by someone viewing the display from near normal incidence. Redirecting these oblique rays into a narrower on-axis cone increases the brightness perceived by the viewer without increasing the power consumption. However, the cost of adding these brightness enhancement layers must be traded off against the cost of adding more lamps or any other technique for increasing the amount of light generated to achieve an equivalent level of viewer brightness. Examples of this type of brightness enhancement can be found in U.S. Pat. Nos. 5,917,664, 6,091,547, 6,356,391 and 6,456,437, the disclosures of all of which are incorporated herein by reference. Another innovative approach to increase the brightness efficiency known as polarization recycling is illustrated in FIG. 3 and more specifically in FIG. 4. A typical backlight emits equal amounts of both planes of polarization but the absorptive polarizer on the side of the display facing the backlight absorbs essentially all of one polarization while transmitting the majority of the desired plane of polarization. Thus, slightly more than ½ of the light generated by the backlight is absorbed and never reaches the viewer. By adding a reflective polarizer before the absorptive polarizer, a fraction of the undesired plane of polarization is reflected back towards the backlight where multiple scattering events ultimately cause it to return to the reflective polarizer. The multiple scattering events undergone by this returned light also rotate its plane of polarization so that some of what was the undesired plane of polarization has been converted to the desired plane of polarization and this desired plane of polarization is now transmitted by both the reflective polarizer and the absorptive polarizer. This process is recursive with the net result that some of the light that would have ordinarily been absorbed by the absorptive polarizer is recycled by the reflective polarizer and now contributes to the brightness seen by the viewer. Reflective polarizers suitable for this type of brightness enhancement can be made with chiral films (e.g., as described in U.S. Pat. No. 6,099,758, which is incorporated herein by reference), multi-layer stacks of isotropic and anisotropic layer pairs (e.g., as described in U.S. Pat. No. 5,965,247, which is incorporated herein by reference) and wire grid polarizers (e.g., as described in U.S. patent application Ser. No. 11/289,660, which is incorporated herein by reference). It should be noted that in the configuration depicted in FIG. 3, the rear polarizer is not replaced; it continues to provide the high contrast desired for the display. Since in this configuration the reflective polarizer is not responsible for establishing high display contrast, the contrast of the reflective polarizer need not be in the range of several hundred to one, contrast ratios as small as ten to one have been shown to provide brightness improvements of 50% or larger. As before, the cost of adding this reflective polarizer for polarization recycling must be traded off against the cost of other methods that might provide an equivalent brightness to the viewer. However, since high contrast reflective polarizers are significantly more costly to manufacture than modest contrast reflective polarizers, the modest contrast requirements for this type of brightness enhancement makes it more economically feasible to use this approach.

A further innovation on the polarization recycling method of brightness enhancement described in U.S. Pat. No. 6,025,897 (which is incorporated herein by reference) and U.S. patent application Ser. No. 11/289,660 and illustrated by FIG. 5 is the use of a reflective polarizer and eliminating the subsequent backside absorptive polarizer. Since achieving the desired contrast of several hundred to one depends on the primary polarizers having a contrast ratio this high or higher, this arrangement is only viable if the contrast of the reflective polarizer is at least several hundred to one. If a high contrast reflective polarizer is achievable, this further innovation has the benefit of eliminating the absorptive polarizer which saves cost and simplifies manufacturing. Thus, the increase in cost of manufacturing a high contrast reflective polarizer versus that of a modest contrast reflective polarizer must be traded off against the cost of absorptive polarizer that would be replaced.

Thus, there is a need for a manufacturing method for reflective polarizers that can achieve high contrast ratios yet have costs that are substantially less than those normally encountered in making a high contrast ratio reflective polarizer.

### BRIEF DESCRIPTION OF THE DRAWINGS

Objects and advantages of the invention will become apparent upon reading the following detailed description and upon reference to the accompanying drawings in which:

FIG. 1 is a schematic diagram of a typical LCD of the prior art.

FIG. 2 is a schematic diagram of another typical LCD of the prior art.

FIG. 3 is schematic diagram of a typical LCD of the prior art.

FIG. 4 is schematic diagram of a typical LCD of the prior art.

FIG. 5 is schematic diagram of a typical LCD of the prior art.

FIG. 6 is a schematic diagram of a modest contrast reflective polarizers according to an embodiment of the present invention.

FIG. 7 is combining the modest contrast reflective polarizers in tandem to result in an inexpensive high contrast reflective polarizer.

FIG. 8 is a schematic diagram of a typical LCD with combining two modest performance polarizers in tandem according to another embodiment of the present invention

FIGS. 9A-9G depict different configurations of two polarizers in tandem arrangements.

### DESCRIPTION OF THE SPECIFIC EMBODIMENTS

Although the following detailed description contains many specific details for the purposes of illustration, anyone of ordinary skill in the art will appreciate that many variations and alterations to the following details are within the scope of the invention. Accordingly, the embodiments of the invention described below are set forth without any loss of generality to, and without imposing limitations upon, the claimed invention.

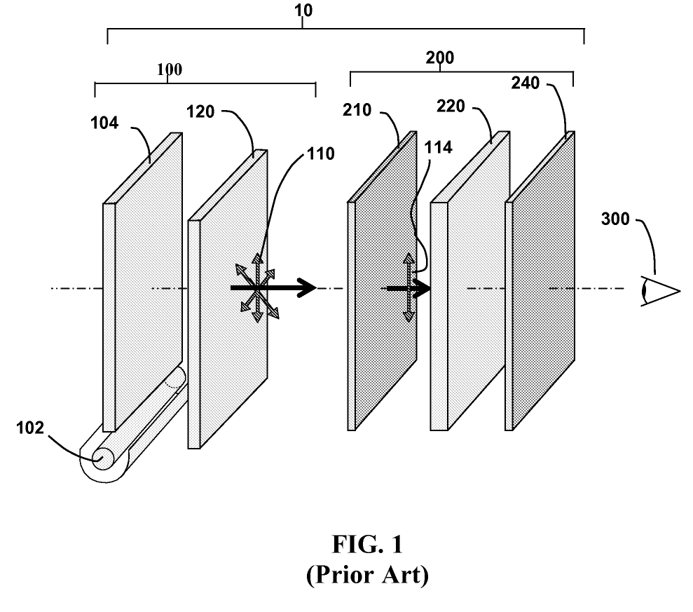

As seen in FIG. 1, in its minimal form, a liquid crystal display (LCD) 10 is composed of two major sub-assemblies, a backlight assembly 100 and a liquid crystal panel assembly 200. The backlight assembly 100 is minimally composed of a light source 102, a light guide 104 and a diffuser 120 to homogenize the spatial variations in the intensity of the light emanating from the backlight. The illumination 110 provided by the backlight is unpolarized. The liquid crystal panel assembly 200 is minimally composed of two absorptive polarizers 210 and 240 on either side of a liquid crystal array 220. Unpolarized light 110 emanating from the backlight is converted to polarized light by polarizer 210. One plane of polarization 114 is transmitted by polarizer 210 while the orthogonal plane of polarization is absorbed by polarizer 210. The plane polarized light 114 that is transmitted by polarizer 210 is subsequently incident on the liquid crystal array whereupon, depending on the voltage applied to each liquid crystal pixel, the plane of polarization is either rotated or not. The second absorptive polarizer 240 transmits the light emanating from the liquid crystal array in proportion to the degree of polarization rotation imparted by the liquid crystal pixels.

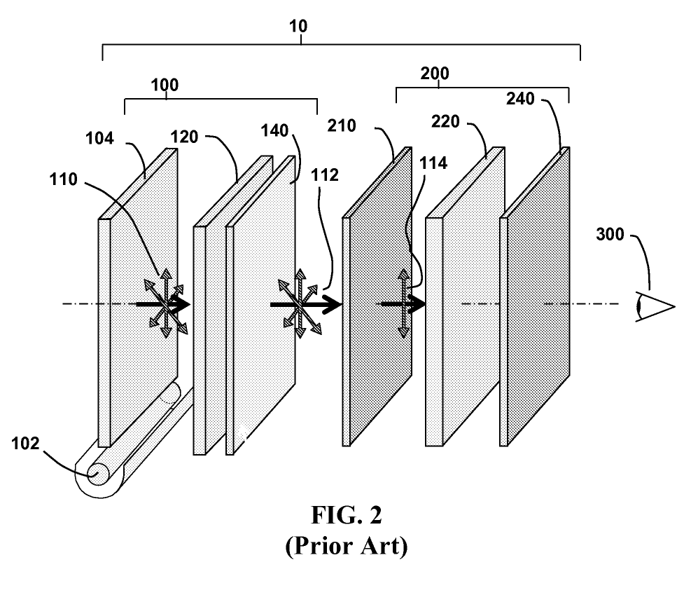

As seen in FIG. 2, the basic LCD described schematically in FIG. 1 may be augmented with a brightness enhancement layer 140 to improve the brightness perceived by the viewer 300. The brightness enhancing layer or layers redirect the light rays emanating from the backlight at oblique angles into a narrower cone of rays. Without the brightness enhancement layer(s) 140 the oblique rays would exit at such a steep angle that they would not be included in the cone of rays available to the viewer 300. Thus, a brightness enhancement layer increases the number of rays that are within the viewing cone of the observer 300 without increasing the amount of light generated by the backlight.

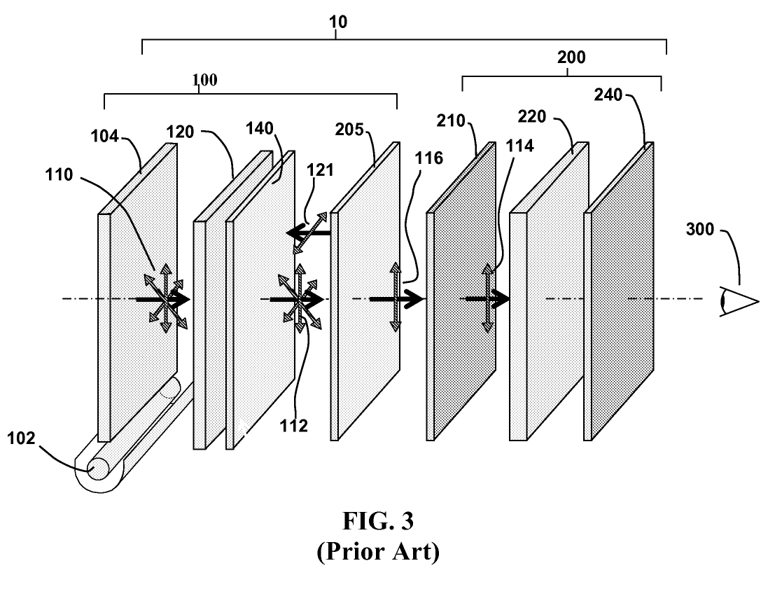

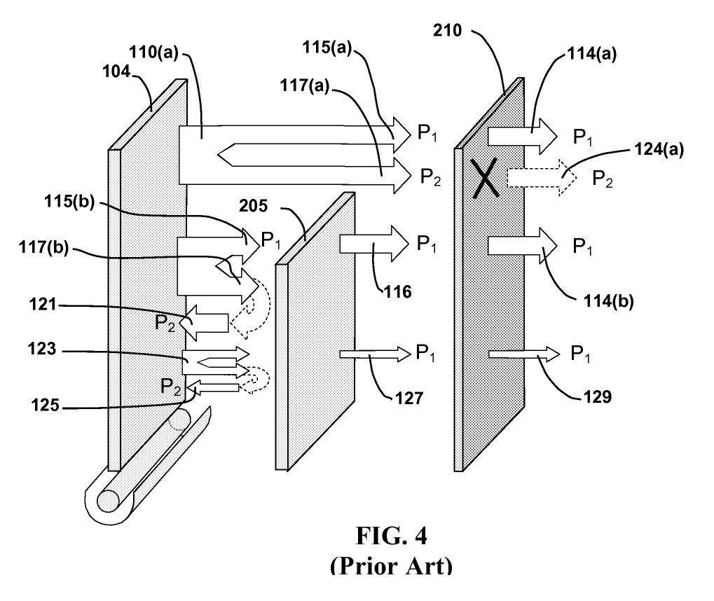

As seen in FIG. 3, a further enhancement of the brightness of an LCD as perceived by a viewer can be obtained by an innovation referred to as polarization recycling. Inserting a reflective polarizer 205 between the backlight assembly 100 and the liquid crystal panel assembly 200 causes the plane of polarization 121 that would normally be absorbed by the absorptive polarizer 210 to be reflected back towards the backlight. The details of polarization recycling can be described more easily with the aid of FIG. 4. To understand the principle of polarization recycling, FIG. 4 compares two scenarios: (a) a scenario without polarization recycling and (b) with polarization recycling. Considering the scenario without polarization recycling first, the backlight 104 generates unpolarized light 110(a) which can be represented as equal amounts of two orthogonal planes of polarization 115(a) and 117(a). Absorptive polarizer 210, usually positioned between the liquid crystal array and the backlight assembly, transmits one plane of polarization 114(a), desirably with little attenuation, while substantially absorbing the orthogonal plane of polarization 124(a). (The ratio of intensity of the transmitted plane of polarization 114(a) to intensity of the absorbed plane of polarization 124(a) is referred to as the contrast ratio of the polarizer.) If the polarizer 210 has a high transmission of the preferred plane of polarization, then the intensity of the light available for modulation by the liquid crystal array is just the intensity of the transmitted plane of polarization 114(a).

In the second scenario, polarization recycling is achieved by inserting a reflective polarizer 205 between the backlight 104 and the polarizer 210. As before the backlight assembly produces essentially equal quantities of two orthogonal plane of polarization 115(b) and 117(b). The reflective polarizer transmits one plane of polarization 116 and importantly reflects the orthogonal plane of polarization 117(b) back towards the backlight. The reflected plane of polarization 121 undergoes multiple scattering events in the backlight assembly and because the backlight assembly has low absorption, the reflected light 121 reemerges towards the viewer as unpolarized or partially unpolarized light 123. A fraction 127 of the reemerging light 123 that is polarized parallel to the plane of high transmission of the reflective polarizer 205 will be transmitted and the remainder 125 reflected back again to the backlight whereupon the process repeats. The net result is that in the case of polarization recycling, the sum of the intensity of the components 116 and 127, and subsequent iterations, is greater than the intensity 115(a) without polarization recycling.

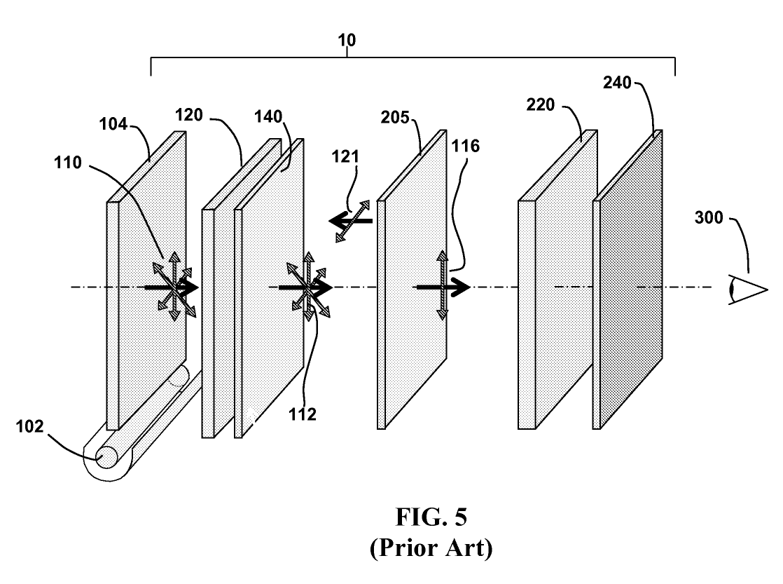

Referring back to FIG. 1, the contrast of an LCD that is perceived by a viewer is nearly completely dependent on the contrast ratio resulting from the combination of the two polarizers that sandwich the liquid crystal array; if either of these two polarizers alone has low contrast, the perceived contrast will be no greater than the lower of the two contrast values. If a reflective polarizer has sufficiently high contrast, it can be employed as both a polarization recycling element and as a contrast determining polarizer by eliminating the need for the rear polarizer 210. This configuration is illustrated in FIG. 5 and is described in U.S. Pat. No. 6,025,897 for multilayer Bragg reflector type of reflective polarizers (as described in U.S. Pat. No. 5,965,247 and others) and for wire grid type reflective polarizers in U.S. patent application Ser. No. 11/289,660 and is depicted in FIG. 5. In the configuration depicted in FIG. 5, the contrast perceived by the viewer 300 is that produced by the combination of the reflective polarizer 205 and the absorptive polarizer 240. In the configuration depicted in FIG. 5, the requirements for the quality of the reflective polarizer, specifically its contrast, are much higher that the reflective polarizer requirements for the configuration depicted in FIG. 3.

There are three distinct approaches to making reflective polarizers: (1) multilayer stacks of isotropic/anisotropic pairs of polymer films such as those described in U.S. Pat. No. 5,965,247, which is incorporated herein by reference, and others, (2) chiral liquid crystal films such as those described in U.S. Pat. No. 6,099,758, which is incorporated herein by reference, and others and (3) wire grid polarizers such as those described in U.S. Pat. Nos. 4,049,944 and 6,122,103, both of which are incorporated herein by reference, and others. Of these three approaches, only the wire grid polarizer approach has been able to demonstrate contrast ratios sufficiently high to be used singly as the polarizing element 205 in the configuration depicted in FIG. 5. However, to achieve the high contrast levels needed in this configuration, expensive lithography and etching processes are needed to fabricate these high contrast wire grid polarizers. It must be noted that the cost of manufacturing modest performance wire grid polarizers can be significantly less expensive than the manufacturing cost of high contrast wire grid polarizers.

Thus, it is desirable to have a reflective polarizer method that can achieve suitably high contrast without incurring the high cost normally encountered in making high contrast reflective polarizers.

Embodiments of the present invention makes it possible to use inexpensive fabrication technology capable of manufacturing modest contrast reflective polarizers and combining the modest contrast reflective polarizers in tandem to result in an inexpensive high contrast reflective polarizer suitable for use in the configuration depicted in FIG. 5.

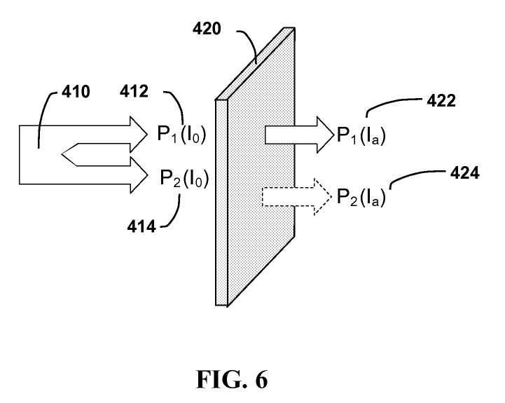

In FIG. 6, unpolarized light 410, consisting of equal amounts of two orthogonal planes of polarization 421 and 414, is used to illuminate a polarizer 420. There are two primary measures of the quality of a polarizer, either absorptive or reflective: (1) the contrast; which relates the intensity of the plane of polarization intended to be transmitted 422 to the intensity of the plane of polarization intended to be extinguished 424 and (2) the parallel transmission, i.e., the intensity of the plane of a polarization that is intended to be transmitted 422 compared to the intensity of that plane of polarization incident on the polarizer 414. A third and often useful polarizer attribute, perpendicular transmission, can be computed from these two. The parallel transmission 422 is the percentage of the incident plane of polarization that is intended to be transmitted relative to that actually transmitted and the contrast is the ratio of the intensities of the two orthogonal planes of polarization transmitted. Since, for unpolarized incident light 110, the incident intensity of the plane of polarization that is intended to be extinguished is the same as that of the plane of polarization intended to be transmitted, dividing the parallel transmission value by the contrast gives the perpendicular transmission 424.

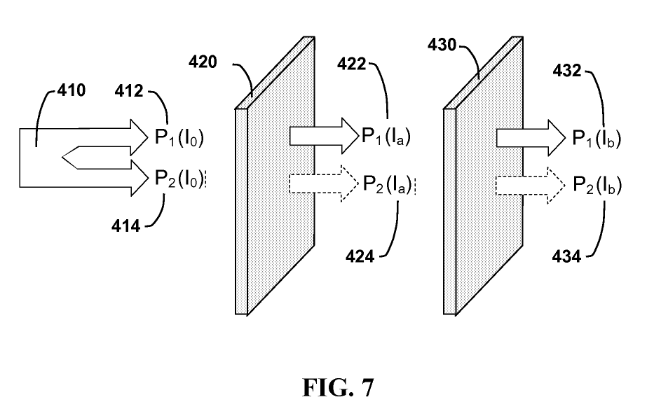

The effect of placing two polarizers 420 and 430 in tandem can be described with the aid of FIG. 7. The overall contrast of the combined polarizers can be determined by multiplying the corresponding transmission coefficients of the respective polarizers. For example, the first polarizer 420 has a parallel transmission of 422 which should be multiplied by the parallel transmission 432 of the second polarizer 430. Similarly, the perpendicular transmission 424 of the first polarizer 420 should be multiplied by the perpendicular transmission 432 of the second polarizer 430. The resulting aggregate parallel and perpendicular transmission values may be divided to give an aggregate contrast value for the tandem pair. The following numerical example highlights the dramatic contrast improvement that can be achieved with a tandem pair of modest contrast polarizers.

First polarizer:
Contrast=50
Parallel Transmission=85%
Perpendicular Transmission=(85%/50)=1.7%

Second polarizer:
Contrast=50
Parallel Transmission=85%
Perpendicular Transmission=(85%/50)=1.7%

Combined performance of tandem polarizers:
Contrast=2,491
Parallel Transmission=(85%×85%)=72%
Perpendicular Transmission=(1.7%×1.7%)=0.029%

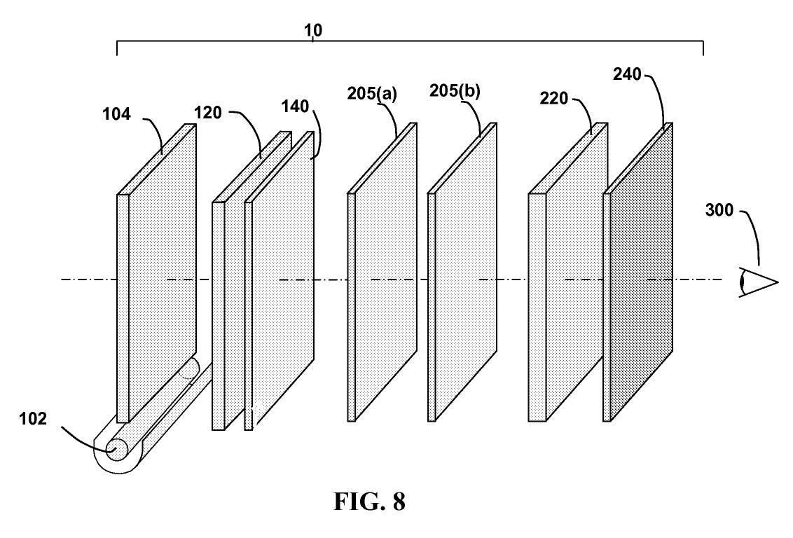

This numerical example clearly shows that combining two modest performance polarizers in tandem as shown in FIG. 8 easily achieves the high contrast required (e.g., greater than about 300) of a reflective polarizer for use in the configuration depicted in FIG. 5. In FIG. 8, a tandem reflective polarizer made up of two reflective polarizers 205(a), 205(b) are placed in tandem in place of the single reflective polarizer 205 in an apparatus of the type depicted in FIG. 5. The reflective polarizers 205(a), 205(b) may be made in accordance with any of the three distinct approaches described above. In a preferred embodiment, at least one of the two reflective polarizers is a wire-grid polarizer. In addition, both reflective polarizers 205(a), 205(b) may be wire grid polarizers.

The second polarizer 240 is positioned between the LCD array and a viewer so that the tandem reflective polarizer, the LCD array and the second polarizer work in cooperation to function as a high contrast electronic display. It is noted that the orientation of the polarization axis of the second absorptive polarizer 240 depends partly on the nature of the LCD array, e.g., whether it is based on a twisted nematic (TN), vertically aligned (VA), in-plane switching (IPS) or optically controlled birefringence (OCB) LCD cell architecture, VA, IPS, OCB). In addition, the orientation of the polarization axis of the second absorptive polarizer depends partly on whether the LCD display 10 is normally dark or normally bright.

For example, in a TN display, which rotates the polarization 90°, a normally dark display will have the polarization axes of the tandem reflective polarizers 205(a), 205(b) oriented parallel to the polarization axis of the second absorptive polarizer 240. In such a case, light transmitted by the tandem reflective polarizers 205(a), 205(b) will be rotated by the LCD array and absorbed by the second absorptive polarizer 240. In the case of a normally bright TN display the tandem reflective polarizers 205(a), 205(b) and second absorptive polarizer 240 would have orthogonal polarization axes. VA LCD cells by contrast do not rotate the polarization and the polarization axes of the tandem reflective polarizers 205(a), 205(b) and second absorptive polarizer 240 would be perpendicular for a normally dark display and parallel for a normally bright display.

Although two reflective polarizers are shown for the sake of example, embodiments of the invention may utilize three or more reflective polarizers in tandem.

Wire grid polarizers of a size suitable for use in a display apparatus may be mass manufactured, e.g., as set forth in U.S. patent application Ser. No. 11/289,660. By way of example, the wire grid polarizer(s) may include a plurality of substantially-straight metallic lines of predetermined periodicity A formed on a thin film substrate. The periodicity A may be between about 50 nanometers and about 500 nanometers. The lines may cover a region approximately 4 centimeters to about 200 centimeters in length and approximately 4 centimeters to about 200 centimeters in width.

The cost of producing two (or more) modest contrast reflective polarizers can be substantially less than the cost of producing one, single high-contrast reflective polarizer. Additionally, fabrication technology that may be incapable of achieving the required high contrast at any cost may now be utilized to meet the high contrast needs of this more demanding configuration.

While the values used in numerical example above are for two identical polarizers, the arguments made would apply equally as well to dissimilar tandem polarizers. In the case of dissimilar reflective polarizers, it would be advantageous, from a brightness enhancement point of view, to position the polarizer with the higher reflectivity on the side closest to the backlight assembly. In this configuration, the maximum amount of light is reflected back towards the backlight for recycling.

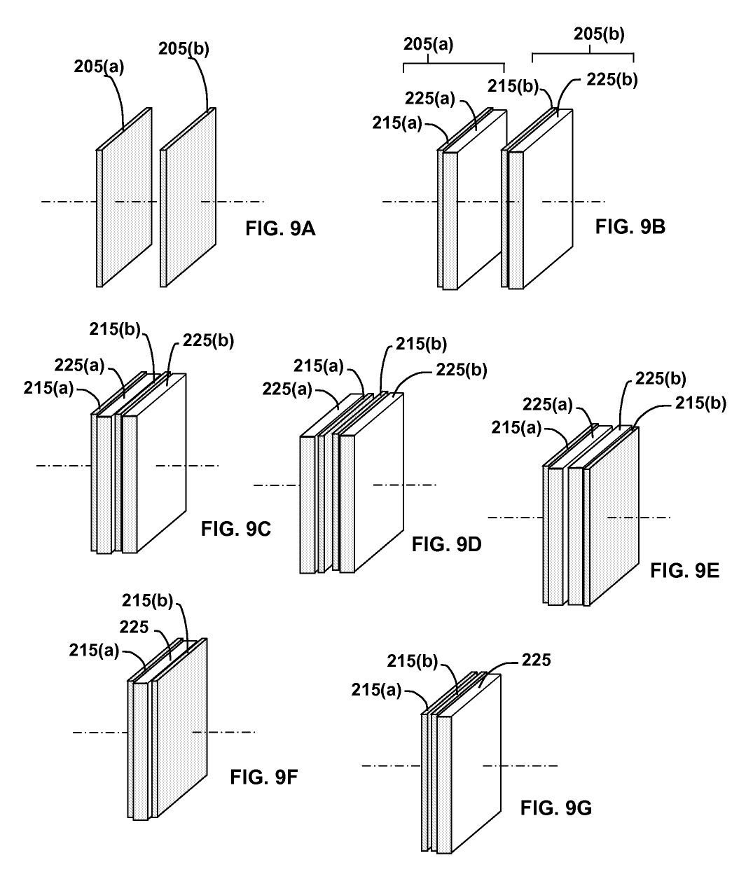

As indicated in FIGS. 9A-9G, there are many ways we anticipate that could be used to assemble the two polarizers in a tandem arrangement. For example as shown in FIG. 9A, two reflective polarizers 205(a), 205(b) are arranged in tandem. In FIG. 9B the tandem polarizer arrangement contains an air gap between the reflective polarizer 205(a) and reflective polarizer 205(b) wherein polarizer 205(a) is composed of reflective polarizer layer 215(a) on a transparent substrate 225(a) similarly reflective polarizer 205(b) is composed of polarizer layer 215(b) on substrate 225(b). Alternatively, as illustrated in FIG. 9C, polarizers 205(a) and 205(b) could be bonded together without an air gap separating them. Similarly, as shown in FIG. 9D the tandem polarizers could be bonded together without an air gap but in a face-to-face arrangement as opposed to the front-to-back arrangement illustrated in FIG. 9C. A further example of an arrangement for bonding two substrate supported polarizers, depicted in FIG. 9E, is to join them back-to-back. Furthermore, in some applications it may be advantageous for the two polarizing layers 215(a) and 215(b) to be supported by a common transparent substrate. FIG. 9F illustrates the arrangement where the layers 215(a) and 215(b) are on opposite sides of the transparent substrate 225 while FIG. 9G illustrates the two polarizing layers 215(a) and 215(b) on the same side of the transparent substrate 225.

While the above is a complete description of the preferred embodiment of the present invention, it is possible to use various alternatives, modifications and equivalents. Therefore, the scope of the present invention should be determined not with reference to the above description but should, instead, be determined with reference to the appended claims, along with their full scope of equivalents. Any feature, whether preferred or not, may be combined with any other feature, whether preferred or not. In the claims that follow, the indefinite article “A” or “An” refers to a quantity of one or more of the item following the article, except where expressly stated otherwise. The appended claims are not to be interpreted as including means-plus-function limitations, unless such a limitation is explicitly recited in a given claim using the phrase “means for.

What is claimed is:

1. A direct view display apparatus, comprising:
a source of backlight;
a liquid crystal array;
a tandem reflective polarizer having two or more reflective polarizer elements disposed in tandem between the source of backlight and the liquid crystal array; and
a second polarizer, wherein the liquid crystal array is disposed between the tandem reflective polarizers and the second polarizer, wherein the second polarizer is an absorptive polarizer.

2. The apparatus of claim 1 wherein the two or more reflective polarizer elements include one or more wire grid polarizers.

3. The apparatus of claim 2 wherein the one or more wire grid polarizers include a plurality of substantially-straight metallic lines of predetermined periodicity A formed on a thin film substrate, wherein the lines cover a region approximately 4 centimeters to about 200 centimeters in length and approximately 4 centimeters to about 200 centimeters in width, wherein the periodicity A is between about 50 nanometers and about 500 nanometers.

4. The apparatus of claim 1 wherein the two or more reflective polarizer elements include one or more stacks of isotropic/anisotropic pairs of polymer films.

5. The apparatus of claim 1 wherein the two or more reflective polarizer elements include one or more chiral liquid crystal polarizer films.

6. The apparatus of claim 1 wherein the two or more reflective polarizer elements include at least two wire grid polarizers arranged in tandem.

7. The apparatus of claim 1 wherein the tandem reflective polarizer is characterized by a contrast ratio greater than about 300 as a result of a combined effect of the two or more reflective polarizers.

8. The apparatus of claim 1 wherein the tandem reflective polarizer includes a first reflective polarizer and a second reflective polarizer with an air gap between the first and second reflective polarizers.

9. The apparatus of claim 8 wherein the first or second reflective polarizer includes a reflective polarizer layer on a transparent substrate.

10. The apparatus of claim 1 wherein the tandem reflective polarizer includes a first reflective polarizer bonded to a second reflective polarizer without an air gap between the first and second reflective polarizers.

11. The apparatus of claim 10 wherein the first and second reflective polarizers are joined face-to-face.

12. The apparatus of claim 10 wherein the first and second reflective polarizers are joined back-to-back.

13. The apparatus of claim 10 wherein the first and second reflective polarizers are joined front-to-back.

14. The apparatus of claim 1 wherein the tandem reflective polarizer includes a first reflective polarizer and a second reflective polarizer bonded to a transparent substrate, wherein the transparent substrate is between the first and second reflective polarizers.

15. The apparatus of claim 1 wherein the tandem reflective polarizer includes a first reflective polarizer bonded to a transparent substrate and a second reflective polarizer bonded to the first reflective polarizer, wherein the first reflective polarizer is between the transparent substrate and the second reflective polarizer.
